(19) United States
(12) Patent Application Publication
(10) Pub. No.: US 2004/0172306 A1
(43) Pub. Date: Sep. 2, 2004

(54) Medical data entry interface

(75) Inventors: Eric Wohl, Austin, TX (US); Randolph Lipscher, Austin, TX (US)

Correspondence Address: TOLER & LARSON & ABEL L.L.P., 5000 PLAZA ON THE LAKE STE 265, AUSTIN, TX, 78746, US

(73) Assignee: RECARE, Inc.

(21) Appl. No.: 10/723,429

(22) Filed: Nov. 26, 2003

Related U.S. Application Data
(60) Provisional application No. 60/430,249, filed on Dec. 2, 2002.
(60) Provisional application No. 60/430,450, filed on Dec. 3, 2002.

(51) Int. Cl. G06F 17/60

(52) U.S. Cl. 705/3

(57) ABSTRACT

The disclosure is directed to a computer generated user interface screen associated with a patient. The user interface screen includes an interface form component associated with a patient condition and a contextual link associated with available contextual data. The available contextual data is associated with the patient condition.

### CROSS-REFERENCE TO RELATED APPLICATION(S)

The present application claims priority from U.S. provisional patent application No. 60/430,249, filed Dec. 2, 2002, entitled “Medical data entry interface,” naming inventors Eric Wohl and Randolph Lipscher, which application is incorporated by reference herein in its entirety.

The present application claims priority from U.S. provisional patent application No. 60/430,450, filed Dec. 3, 2002, entitled “Medical data entry interface,” naming inventors Eric Wohl and Randolph Lipscher, which application is incorporated by reference herein in its entirety.

### TECHNICAL FIELD OF DISCLOSURE

This disclosure, in general, relates to an interface for presenting and entering medical information. More specifically, this disclosure relates to a method and system for presenting medical data associated with a patient to a medical professional.

### BACKGROUND

Medical professionals increasingly rely on electronic medical record systems. These systems are typically used to store patient information including medical history and insurance information. These typical systems permit a medical professional such as a nurse, doctor, record keeper, or accounting professionals, to retrieve and edit data associated with a patient. However, these typical systems are often cumbersome and inconvenient for use by a doctor both during a patient visit and when reviewing patient files. Some of such systems hide or prevent direct access to historical medical information that may be useful in diagnosing current conditions or causes for symptoms associated with an office or emergency room visit. With such systems, doctors or nurses seek the medical information using other systems or interfaces. The information is not linked to or accessible from the diagnosis forms. Typical system are also limited in that they do not allow historic data to be updated from the diagnosis interface and do not display data pertinent to a present set of conditions or symptoms.

As such, typical systems are difficult to use and navigate. Therefore, an improved electronic medical entry interface would be desirable.

### SUMMARY OF THE INVENTION

In one exemplary embodiment, the disclosure is directed to a computer generated user interface screen associated with a patient. The user interface screen includes an interface form component associated with a patient condition and a contextual link associated with available contextual data. The available contextual data is associated with the patient condition.

In another exemplary embodiment, the disclosure is directed to a system including a processor and storage. The storage is coupled to the processor. The storage includes instructions for accessing a patient record and instructions for providing a user interface screen. The user interface screen includes a medical form component associated with a patient condition and a contextual link associated with available contextual data. The available contextual data is associated with the patient condition.

In a further exemplary embodiment, the disclosure is directed to a medical interface. The medical interface includes a plurality of interface pages wherein at least one page of the plurality of interface pages includes a present illness form component associated with a patient condition and a contextual link associated with the patient condition and wherein the contextual link is configured to access a second page associated with the available contextual data. The contextual link has a label indicative of available contextual data. The second page includes a link to the at least one page that includes the present illness form component.

In an addition exemplary embodiment, the disclosure is directed to a method of providing a medical documentation interface. The method includes receiving a request for an interface screen associated with a patient, accessing data associated with the patient, and providing the interface screen including a medical form component associated with a patient condition and a contextual link associated with available contextual data. The available contextual data is associated with the patient condition.

In another exemplary embodiment, the disclosure is directed to an interface device including a display configured to display an interface screen comprising an interface form component associated with a patient condition and a contextual link associated with available contextual data. The available contextual data is associated with the patient condition.

### BRIEF DESCRIPTION OF FIGURES

For a more complete understanding of the present disclosure and advantages thereof, reference is now made to the following description taken in conjunction with the accompanying drawings in which like reference numbers indicate like features and wherein:

FIG. 1 is a block diagram depicting a system.

FIG. 2 depicts an exemplary embodiment of a server.

FIG. 3 depicts an exemplary system and communication path.

FIG. 4 is a schematic block diagram of an exemplary embodiment of an interface.

FIGS. 5 through 13 are pictorials that illustrate exemplary embodiments of interfaces.

FIGS. 14 and 15 are flow charts that depict exemplary methods of handling patient data.

### DETAILED DESCRIPTION

When diagnosing or treating a patient, medical and social history gives context to the symptoms or findings. This context enables doctors and other medical professionals to narrow the potential scope of a search for cause. Therefore, readily accessible medical data accelerates diagnosis. Accelerating diagnosis leads to faster treatment, fewer tests, less time with a medical professional, and a better record of the consultation. As such, providing easy access to information such as pertinent history and tests leads to lower cost, more effective treatment. The present disclosure is directed to an interface system in which context related information is directly linked to a findings page used for recording observations when diagnosing a patient.

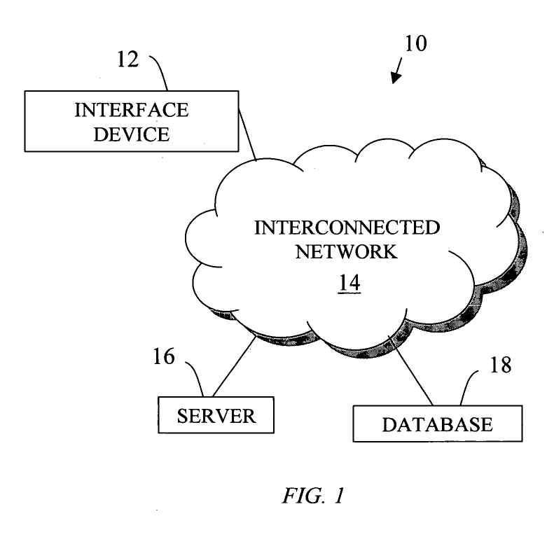

FIG. 1 is a block diagram of a system for delivering an interactive medical records system to a doctor or medical professional. The system 10 delivers an interface that permits easy access to medical and social history. The system includes an interface device 12 connected through a network 14 to a server 16 and database 18. The database 18 may, alternately, be directly connected or integrated with the server 16. Examples of network 14 include a wireless network, Ethernet, token ring, or other interconnected networks. The network may permit communication using protocols such as TCP/IP, FTP, HTTP, SNMP, and SMTP, among others. Using these protocols, among others, the interface device 12 may access and edit data stored on the server 16 or database 18. For example, the server 16 may, upon request, deliver an HTML page or Java applet to the interface device 12. The interface device 12 may then display the page or applet to a medical professional.

The database 18 is a data storage and retrieval system such as a relational database, object oriented database, or file system. The database 18 is configured to store general medical data, such as a master problems list, family history, social history, administrative information, billing data, insurance data, test results, and prescription data. Interactions with the interface device 12 result in updates to the stored data. Further, the server may use data from the database 18 in creating an interactive page or subsequent pages for providing information or collecting additional data.

In one exemplary embodiment, the interface device 12 is a web-enabled wireless handheld device. For example the interface device 12 may be a computer tablet or a personal digital assistant (PDA) portable or handheld computer. The interface 12 communicates with the server 16 and/or database 18. The server 16 generates an HTML or XML findings page associated with a patient or task in a medical workflow. The page includes links to historical data and/or test results. These links may be consistent between various pages, specific to a particular page, or dynamically adapted to data such as medical history, findings, insurance carrier rules, and prescription rules. The server 16 delivers web pages to the interface device 12 through the interconnected network 14, and the interface device 12 displays the page and permits interactivity. The medical professional may link to the historical data or test results to seek context to the findings. Pages associated with the links may have controls for returning to the findings page.

In an alternate embodiment, the server 16 and/or the database 18 may be incorporated with the interface device 12. In this case, the interconnected network may comprise the internal communications network of the device and/or software based interactivity protocols or application program interfaces (APIs).

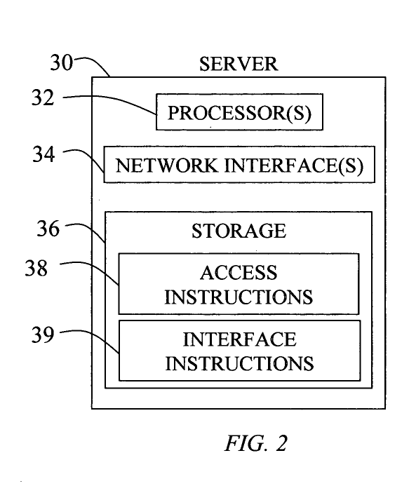

FIG. 2 depicts an exemplary embodiment of a server. The server 30 may include computational circuitry configured to access a network. The server 30 may run operating systems, such as Window®-based operating systems, MacOS®-based operating systems, and Unix-based operating systems, among other networkable operating systems.

The server 30 may include one or more processors 32 and one or more network interfaces 34. The one or more processors 32 may be used to interpret instructions or software code configured to provide at least the functionality described below. The one or more network interfaces 34 may be configured to connect to networks and communicate with network standards such as those described in relation to interconnected network 14.

The server 30 also includes storage 36. The storage 36 may be a computer memory for storing data and software instructions and code, such as read only memory (ROM), random access memory (RAM), magnetic drives such as hard drives, floppy drives and removable drives, optical drives such as CD and DVD drives, flash memory, and other digital storage mediums.

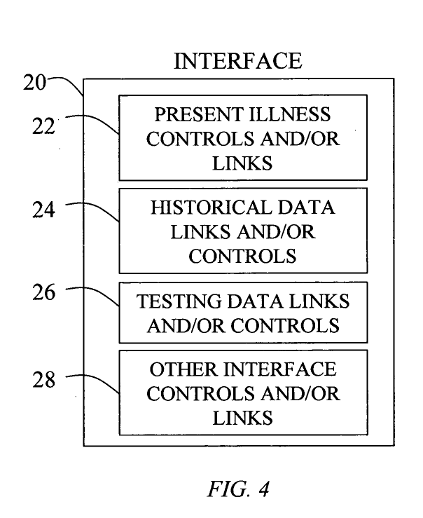

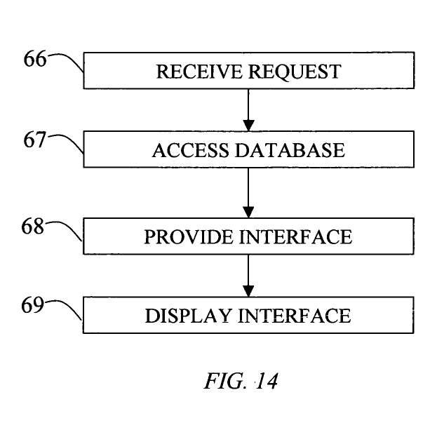

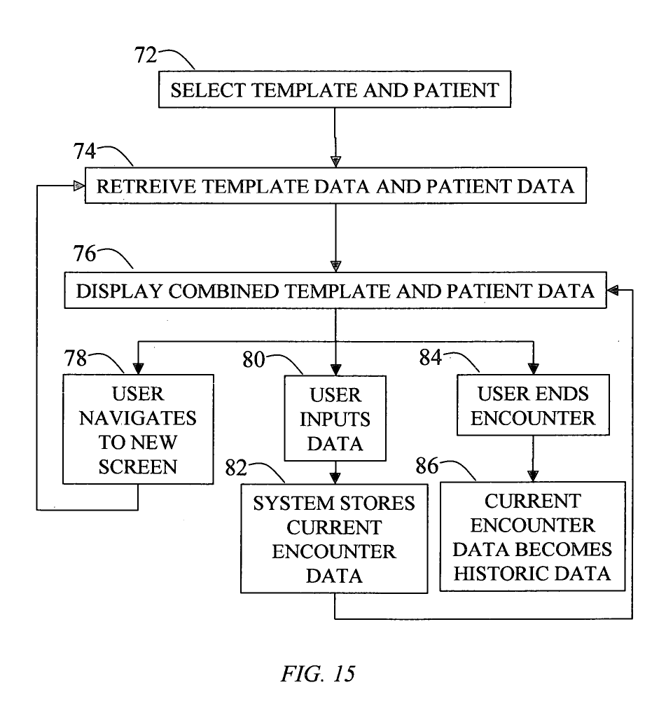

The storage 36 stores access instructions 38 and interface instructions 39. The access instructions 38 permit communication with external systems and database systems. For example, the access instructions provide incoming data request functionality, data request functionality to databases, and provision of an interface. The interface instructions 39 may provide interfaces such as those exemplified in FIGS. 4-13. For example, an interface may be constructed based on an interface template adapted to incorporate specific contextual information associated with patient data, such as medical history, medical conditions, test results, and other patient related data. Furthermore, software instructions may be stored in storage 36 to implement the methods described with reference to FIGS. 14 and 15.

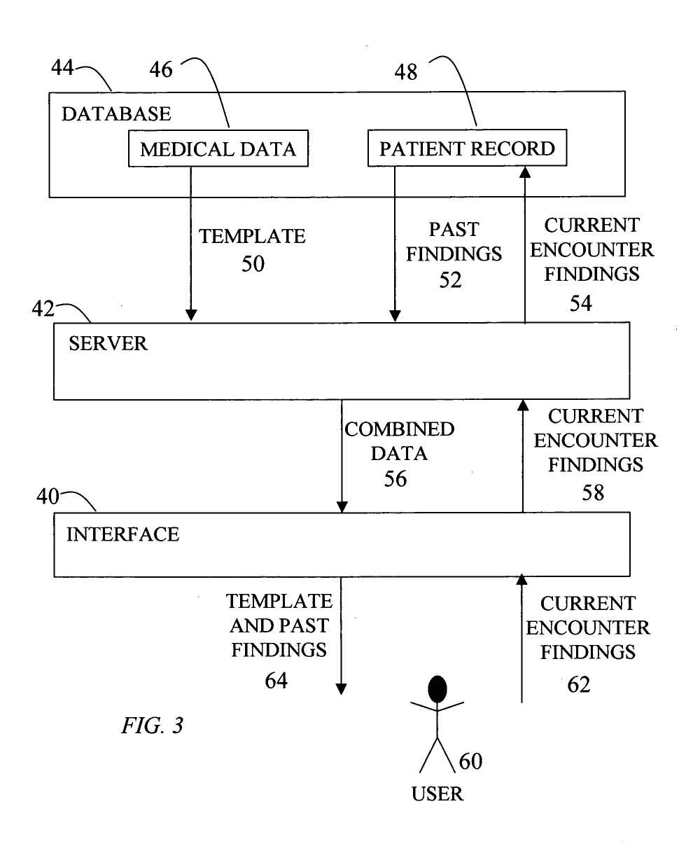

FIG. 3 depicts an exemplary system and a communication path. The system includes a database 44, a server 42, and an interface device 40. The interface device 40, may for example, be a display and input device coupled to the server 42, a computer separate from the server 42, or a portable device such as a laptop system, tablet system, handheld system, or other portable circuitry.

A request received at the interface may be provided to the server 42. The server 42 may access a database 44 that includes medical data 46 and patient records 48. In this exemplary embodiment, the server 42 acquires a template 50 and past findings data 52. The template 50 may be associated with a patient's present illness or condition or reason for consultation, generically referred to as a patient's condition. The template 50 and past findings data 52 are combined to form a combined data interface page 56. The template and past findings are displayed to a user 60 in a page 64.

The user 60 may enter current findings 62, such as findings associated with a past condition or a present illness. These current findings 62 are received at the interface 40 and communicated to the server 42 in a current findings message 58. The current findings 58 are stored in the patient record 48 through a database message 54.

In addition, the template and past findings 64 may include links to further details about the past findings 52 or contextual information. These links may lead to other pages that are formed using a combination of template and patient record data. The other pages may further include a link returning to the referencing page such as the template and past findings page 64.

In one particular embodiment, the database 44 sends template information 50 and past findings 52 to the server 42. The server 42 combines this information into an integrated set of data and sends the combined data 56 to the interface 40. The interface 40 displays a page including a template information and past findings 64 to the user 60. The user 60 inputs information about the patient to the interface 40 as current encounter findings 62. The interface 40 sends current encounter findings 58 to the server 42. The server 42 updates the patient's medical record 48 in the database 44 with current encounter findings 54. In another embodiment, the server functionality is integrated with the interface 40, and the interface 40 communicates directly with the database 44. For example, the interface 40 may retrieve template information 50 and past findings 52 from the database 44 and send current encounter findings 54 to the database 44. FIGS. 4-13 indicate exemplary uses for recording such findings in a medical setting. However, various other uses of such stored data may be envisaged.

FIG. 4 is a block diagram of a findings page associated with a patient's present condition or reason for consultation. The interface 20 includes present illness or findings controls 22, historical data links and/or controls 24, testing data links and/or controls 26, and other interface links and/or controls 28. These elements may be together, separate, or in various combinations.

The present illness controls and/or links 22 are controls and/or links useful for indicating and recording findings, symptoms, and data. For example, these controls may be buttons, check boxes, menus, radio buttons, slide bars, hyperlinks, and text boxes, among others. A medical professional interacts with these controls to record and indicate findings or data associated with a patient. The controls may be a check box for indicating the presence of a finding, a link to an annotation page, a pull-down menu for selecting a qualifier, or a button indicating completion of the page. In one embodiment, a finding is associated with a tri-state check box that allows a user to specify that the finding is “present”, “not present” or “not commented upon” by clicking on the tri-state check box to cycle through the three states. In one embodiment, a finding is associated with a free-text and free-voice input that allows a user, such as an examining physician, to enter text or voice annotations to be associated with the finding. However, various alternative embodiments may be envisaged.

Generally, the output of the present illness controls and/or links 22 are stored in the database and also provide input for billing, artificial intelligence, insurance data, medical history data, selection of pharmaceutical advertisements, and determination of eligibility for medical studies. As such, this data is important for both determining the appropriate therapy as well as other functions.

Historical data links and/or controls 24 are links and/or controls to data useful in providing access to historical data such as patient medical history, patient personal data, surgical history, family history, social history, medications, prescribed risk modification data, and disease or medical condition data. A subset of the historical data links and/or controls 24 may provide access to contextual data. The contextual data may include data associated with specific diseases or conditions, risk modification programs, or summary information. These links or controls may take a similar form to the present illness controls and/or links 22. For example, the links and/or controls 24 may be hyperlinks with an informative text label, buttons, text boxes, and labels with contextual information. These links and/or controls 24 may be a standard set generated with the page. Alternately, the links and/or controls 24 may be dynamically created in accordance with rules associated with the findings, findings page, and contextual or historical data, among others.

For example, the historical data link may be a link with a label specific to a disease or condition such as “diabetes,” “hypertension,” “Alcoholic,” or “pancreatic cancer.” In another embodiment, the link may have a label specific to a drug allergy, such as “Sulfa Allergy.” In a further embodiment, a past medical event or previous injury may be available through a link with a label associated with the event or injury such as “Infarct Details.” In an alternate embodiment, the appearance of a generic label such as “family history” may indicate specific information associated with a present condition or “Prescribed Risk Modification” may indicate enrollment in a risk program. In a further exemplary embodiment, the link may be used to selected therapy details, such as a prescription or drug regimen. The label may summarize the prescription such as listing the prescribed medication. Dosage information may also be summarized in the label. These labels may additionally include summary information, dates, or other reference information.

Similarly, the testing data links and/or controls 26 may take forms similar to the present illness or findings controls and/or links 22 and link to data or information associated with previous test results, among others. The other interface controls and/or links 28 may also take forms similar to the present illness or finding controls and/or links 22. The other interface controls and/or links 28 may function to provide navigation controls, and/or links to various web page locations, among others.

These testing data links and/or controls 26 may also include labels providing summary information. A link may appear when test results are available. The link may include a descriptive label. The link may additionally include a result summary such as “normal” or “abnormal.” For example, the link may describe a test and the result such as “Cholesterol Normal,” or “PSA High.” The link label may further include the test date.

In addition, other links and controls 28 may be used to indicate availability of general medical information and eligibility information. For example, links and controls 28 may indicate availability of general information about previous conditions such as a new study or academic paper on a condition associated with the patient. In another example, the links and controls 28 may indicate that the patient is eligible to participate in a new drug trial or treatment method study. In a further example, the other links and controls 28 may indicate that information associated with a patient's insurance company or the insurance company's preferred treatment method is available.

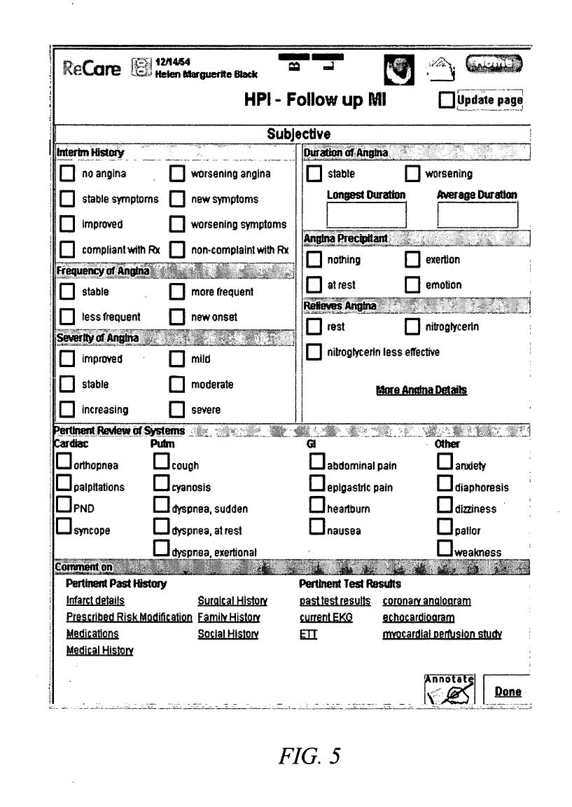

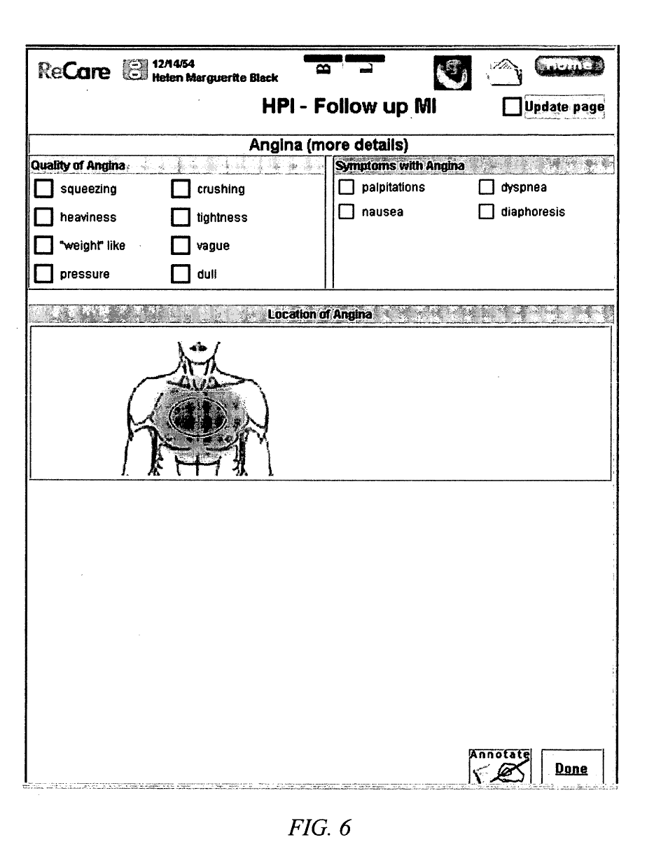

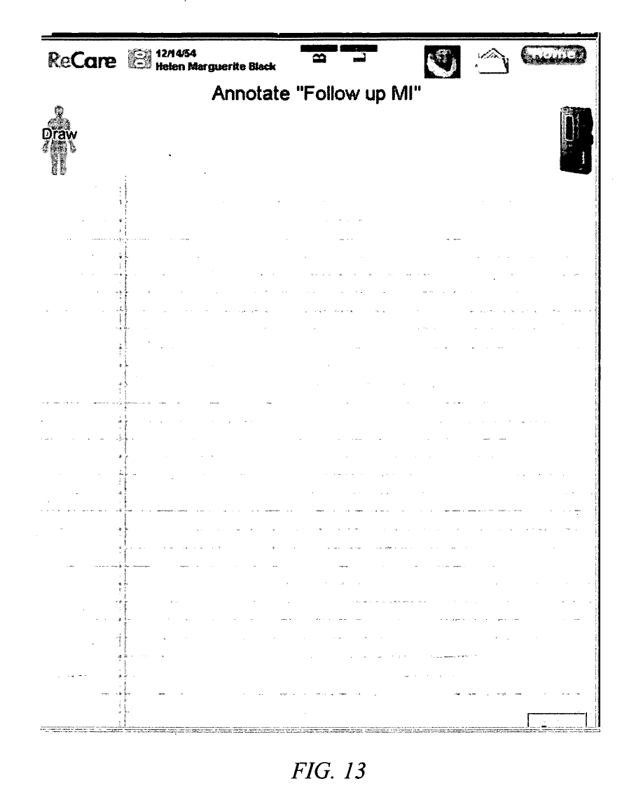

FIG. 5 is an exemplary embodiment of a findings entry screen with links to contextual information. The page depicts a data page associated with a follow-up exam after a myocardial infarction (MI). Check boxes are seen indicating the answers to a set of screening questions associated with the nature of angina, previous or new symptoms, and reactions to medication, among others. The page also permits the findings to be qualified with a set of check boxes associated with qualifiers. More details may also be entered if necessary by linking through a link labeled “More Angina Details.” The more detailed page may be seen as FIG. 6. Further, more data may be entered on an annotation page discussed in association with FIG. 13. Each of these pages may have a link returning to the findings page of FIG. 5.

In one embodiment, each screen or page corresponds to a template that describes the findings and past medical data that are relevant to the screen or page. In this embodiment, the findings are displayed when the screen is rendered and the past medical data represents a query or filter that is applied to the past medical information about the patient to extract stored information relating to the patient to be displayed.

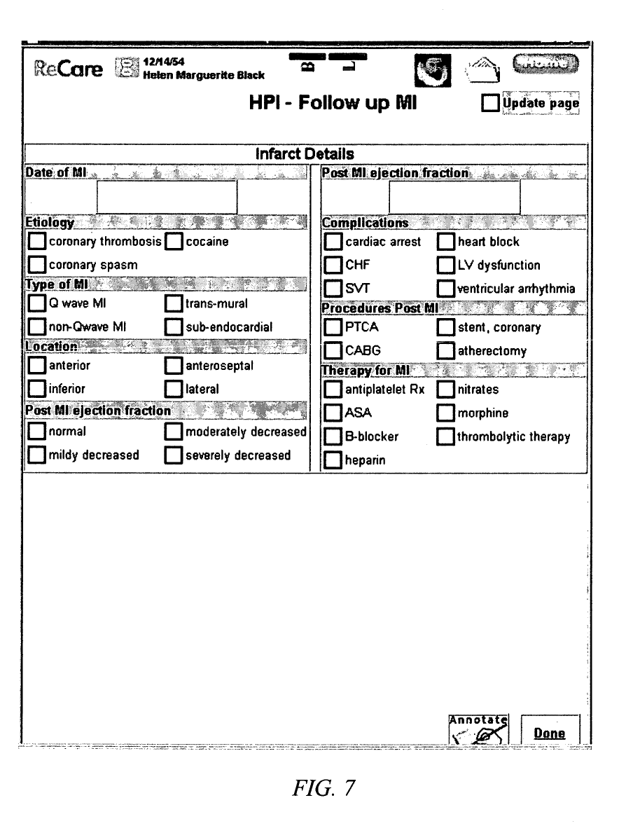

At the bottom of the exemplary page seen in FIG. 5, a “Comment on” section is shown. Within this section are links to historical data such as “Infarct Details”, “Prescribed Risk Modification”, “Medications”, “Medical History”, “Surgical History”, “Family History”, and “Social History”, among others. Each of these may link to data useful in providing context to the findings or symptoms. For example, the “Infarct Details” link may provide a page with data associated with the previous myocardial infarction. This data is exemplified in FIG. 7. Alternately, a link, label, or text box may indicate a context such as “Alcoholic.” Each of these links may appear on every present illness page. Alternately, links may be supplied for a given finding, context of exam, or dynamically created in accordance with various rules. The rules may reside on the server or be supplied as part of the page. Once a link or control is selected, the system may function to save the data already entered in a permanent or temporary location so that the user may easily return to the page without losing data.

Similarly, a set of links to test data may be seen in the “Comment on” section. These may be links to tests and test results. Further, these links may be statically part of a page associated with a given exam or dynamically created in accordance with test records.

FIG. 7 is an exemplary embodiment of an Infarct Details page as described above. In this exemplary embodiment, the page includes details relating to the prior infarction. The details may be displayed as controls with default values. For example, the page may indicate the etiology of the incident, complications, procedures used, and selected therapy. The system may also permit manipulation of these controls. In this manner, the data may be corrected or missing data may be entered from this screen and stored in the database. The page may also include links back to the present illness page. The server may recreate the page using temporary data. Alternately, the interface device may have stored the present illness page for quick return.

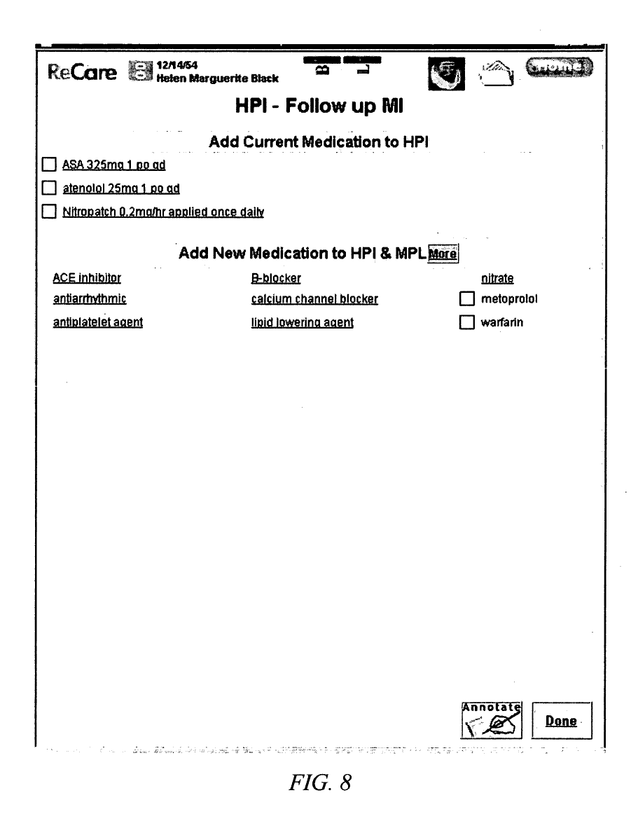

FIG. 8 is an exemplary embodiment of a medications page. For example, findings in the follow-up visit may warrant a change in therapy. Easy access to the existing therapy information may prove useful. In this example, a medications page may aid in determining follow-up therapy. Moreover, the medications page may provide context as to what pharmaceuticals may be prescribed or give further context to the findings in the case of drug interactions or known side effects associated with individual drugs.

In this example, past medical information comprising a listing of medications currently prescribed to the patient is provided. In addition, other potential pharmaceutical therapies associated with the findings or context of the exam are provided. Using this interface, a user may select one of the current medications using the check boxes to explicitly note in the current encounter's history of present illness that the selected medication is a current medication for the patient. For example, if the user checks the “Nitropatch 0.2 mg/hr applied once daily” box, then the HPI narrative generated for the current encounter will include the note “Nitropatch 0.2 mg/hr applied once daily.” In this example, if the user selects the text hyperlink for a current medication, the system displays a screen on which the user can add an annotation. For example, the user might check the “Nitropatch 0.2 mg/hr applied once daily box” and then select the text and add the annotation “Patient forgot to refill Rx and stopped medication 2002-9-1; medication restarted 2002-9-18”. In that case, the HPI narrative generated for the current encounter will include the note “Patient forgot to refill Rx and stopped medication 2002-9-1; medication restarted 2002-9-18.” The user may also add new medications to the patient's HPI and master problem list by selecting from the medications listed. These medications are included in the template because they are medically related to the medical topic being addressed (MI in this cases.) For example, calcium channel blockers may be an additional therapy choice. Alternately, current prescriptions may be changed through selection of another pharmaceutical or dosage. The changes may be stored and the system may reload the findings page.

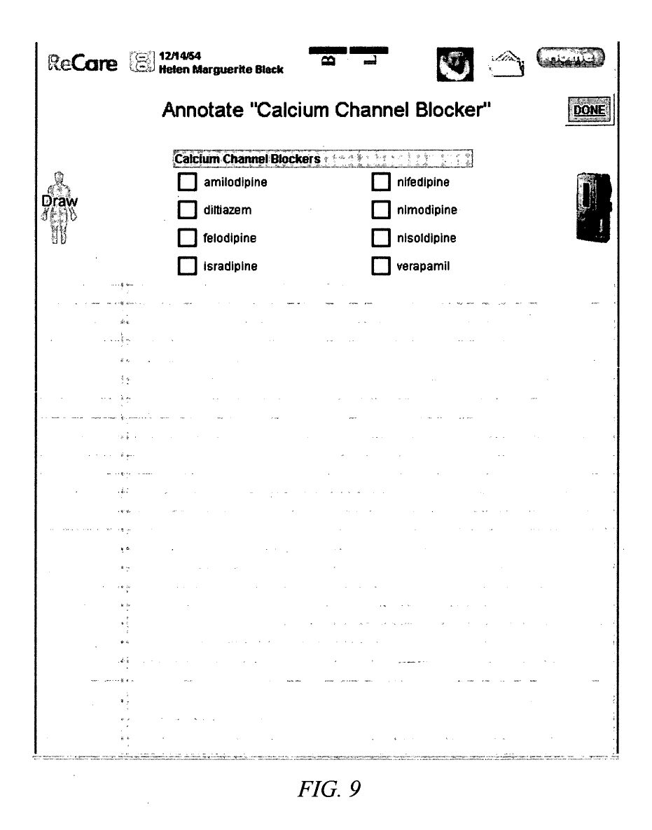

FIG. 9 depicts a calcium channel blocker page. The page lists potential calcium channel blockers. Further, the page may provide a place for notes, controls for prescribing dosage, and other features. The page may also provide links to the present illness page as seen in FIG. 5, or the medications page as seen in FIG. 8. Either page may be updated to reflect a new prescription.

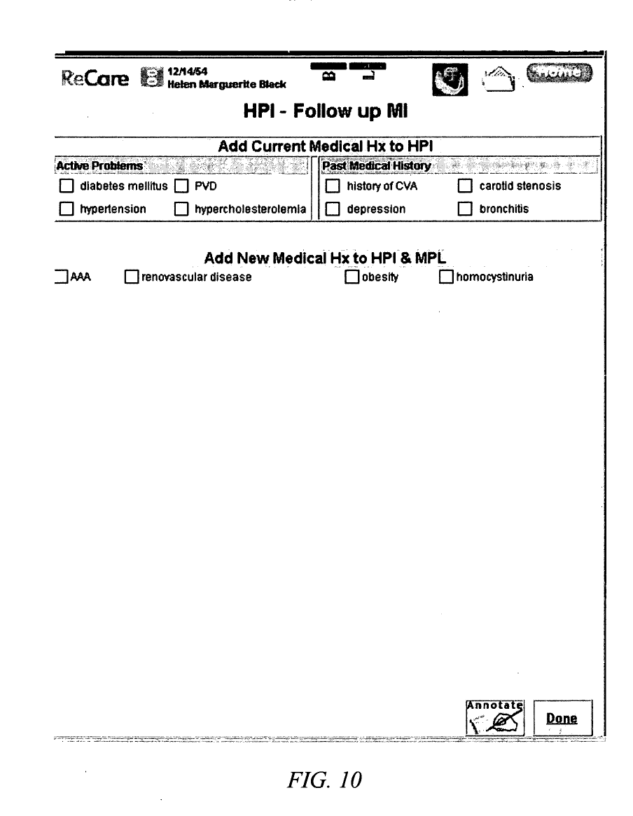

FIG. 10 shows a medical history page. This page contains both current medical history elements from the patient's medical data that are relevant to the topic as well as template elements that are not in the patient's medical data but that are relevant to the topic and that the user may want to add to the HPI (history of present illness) and MPL (master problem list) during the current encounter. In this example, the template comprises a list of finding IDs that are relevant to MI. The system scans the patient's Active Problems List for active problems whose finding IDs are on this list and displays any matching elements in the “Active Problems” portion of the page.

Similarly, the system scans the patient's past encounters to find past findings corresponding to these finding IDs and displays them in the “Past Medical History” portion of the page. This page may also have controls with pre-selected default values indicative of the patient's medical history. In particular, some of the finding IDs that are listed may have an attribute that indicates that they are particularly relevant to the topic, so that if there is a match with the patient's past medical history or active problems, then in addition to displaying the finding as shown here, the initial value of the check-box should be “checked” indicating that by default the problem or finding will be included in the HPI for the current encounter. In such a case, the user may uncheck the element if the user does not want to include information in the current encounter record. Further, the selection of controls, control types, labels on controls, and layout of the page may change in accordance with the patient's medical history, the exam, or other data. For example, diabetes may provide context to a myocardial infarction and indicate a differing therapy than that for a patient with hypercholesterolemia alone. In an alternate example, diabetes, hypertension, and hypercholesterolemia combined may indicate a differing therapy than hypertension alone. Further, the page may permit editing of medical history and entering of new history.

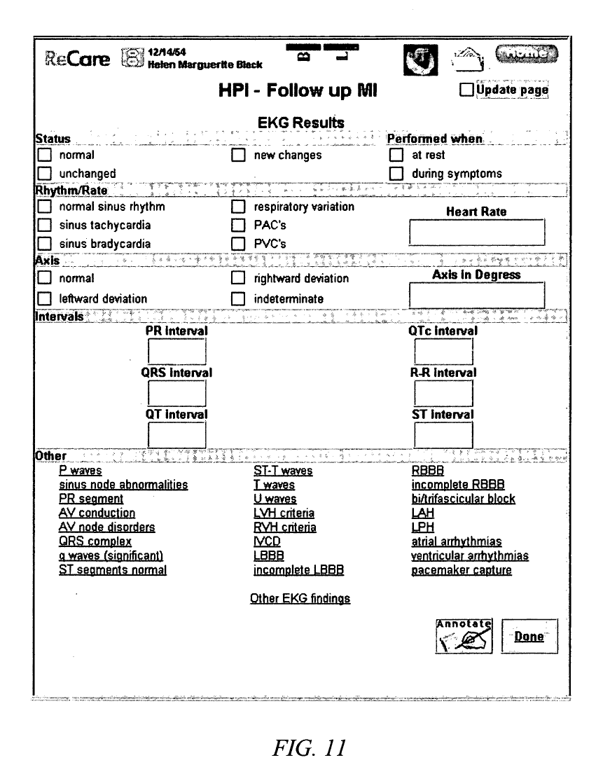

FIG. 11 is an exemplary embodiment of a test result page. In this page, a test result for an EKG may be presented. The page may present information about the test or context of the test, data obtained through the test, and conclusions about the test. Further, the page may provide links to further data and/or definitions of terms associated with the test page.

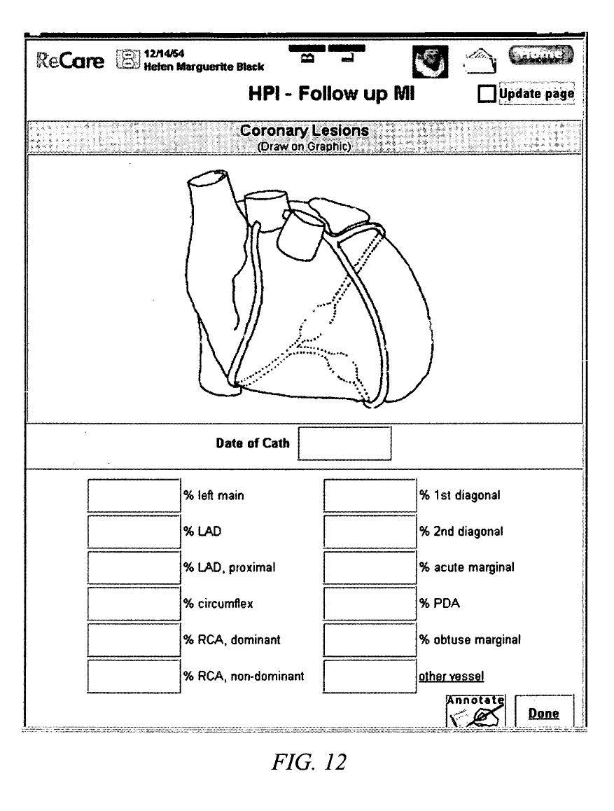

FIG. 12 is a pictorial of an exemplary coronary angiogram. The page may pictorially indicate data associated with a catheterization. Further, data may be displayed, edited, or entered. In other examples, surgical notes and pictorial representations may be provided to aid a subsequent medical professional to understand the previous procedure.

FIG. 13 is an exemplary embodiment of an annotations page. The annotations page may be associated with various parts of the present illness page or medical history. The annotations page may provide a method of entering contextual notes beyond the other controls. In some embodiments, these notes may be dictated, hand written, or typed. In various contexts, links may be provided to previous recordings or notes. The medical professional may also be provided with the option to create a note or recording through links on the findings page. In one exemplary embodiment, the appearance of an annotation link on an HPI interface may indicate a previous annotation or message relating to the condition, treatment, or circumstances.

Often, diagnosis or explanation of a current condition, finding, or symptom is affected by knowledge of previous conditions or medical history. For example abdominal pain may have many causes, such as liver disorders, pancreatic disorders, ulcers, kidney stones, gallstones, polyps, intestinal punctures, hernias, colitis, and infection. However, each requires differing tests for diagnosis and differing treatment once discovered. Past conditions, medications, sexual behaviors, and family history may all be useful in determining the most efficacious path to diagnosis. Medical history, social history, previous tests, and other factors give the symptoms context through which a doctor may more quickly decide on a therapy.

The exemplary interfaces depicted in FIGS. 5-13 may be modified and improved with the addition of multimedia elements, higher resolution graphics, rearrangement of the elements, and other aesthetic modifications. Controls and links may change based on the medical history of the patient, the present illness or point in workflow, insurance guidelines, and other medical related variables.

FIG. 14 depicts an exemplary method of providing a medical interface. A request is received for an interface page, as shown at step 66. The request may specify a particular patient. The system accesses a record in a database, such as a patient record, to retrieve contextual or historic data associated the interface and the patient, as shown at step 67. The system may then provide the interface, as shown at step 68. The interface may be a screen or a set of screens, such as a website, an applet, a web page, or an XML page that is viewed on a display device.

The interface may be displayed to a user, as shown in step 69. The user may interact with the interface to provide additional data or determine how to proceed.

FIG. 15 illustrates the actions taken in an exemplary medical interactive method. As shown at step 72, a template and patient are selected. The template includes information about the topic of the medical encounter. For example, in a particular embodiment there are templates for such encounters relating to diseases or conditions, such as “follow up diabetes”, “follow up MI”, “follow up fracture”, “diabetes”, “MI”, and “annual physical (adult male)”; for encounters relating to complaints such as “chest pain”, “shortness of breath”, “headache”, and “sore throat”; for encounters relating to procedures, medications, or tests such as “refill prescription”, “review recent lab results”, and “follow up angioplasty”. Each template includes a location for contextual data links to a separate page with contextual data, such as a list of relevant findings to the topic and a list of past medical information that are relevant to the topic.

In one embodiment, the user selects the patient and then selects the template to be used. In another embodiment, a second user such as a receptionist selects the patient and template that are to be active for the interface used by the primary user. For example, a receptionist may select the patient and template to be used by the physician. In a third embodiment, a second user selects the patient, the patient fills in a questionnaire, and the system selects a relevant template based on the patient's answers on the questionnaire. In a fourth embodiment, a second user selects the patient and the primary user selects the template.

Once the template and patient have been selected, the system retrieves the template and the patient's medical data that includes medical information about the patient, as shown at step 74. In this embodiment, the template may include a set of findings relevant to the topic of the template and a set of patient data (e.g., past medical information) relevant to the topic of the template. The system retrieves the corresponding patient data. The database of past medical information for a patient includes information from past encounters such as the active problems list, past problems list, current medications list, past medications list, pending labs and procedures list, results from past labs and procedures, family history, and social history. The template indicates which of this past information is relevant and is retrieved. In another embodiment, all patient data is fetched from the database en masse and the system selects the subset to be displayed according to the template.

The system combines this selected patient data and findings according to the template and displays the combined information to the user, as shown at step 76. The user can then input data, as shown at step 80, which the system stores as current encounter data, as shown at step 82, and updates the display. Alternatively, the user can navigate to a new screen corresponding to either a new activity (e.g., switch from “follow up MI” to “follow up diabetes”) or corresponding to a sub-activity within the current activity (e.g., switch from “follow up MI” to “follow up MI medications”), as shown at step 78. In this case, the system retrieves a new template and relevant medical data and displays the new combined information relevant to the new task or subtask. Alternatively, the user can end the encounter with the patient, as shown at step 84, at which point the new data that has been entered is stored as past medical data that can be accessed by the system in the future, as shown at step 86.

The above disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer generated user interface screen associated with a patient, the user interface screen comprising:
an interface form component associated with a patient condition; and
a contextual link associated with available contextual data, the available contextual data associated with the patient condition.

2. The user interface screen of claim 1, wherein the contextual link comprises a label indicative of the available contextual data.

3. The user interface screen of claim 1, wherein the contextual link is configured to access a second user interface screen associated with the available contextual data.

4. The user interface screen of claim 1, wherein the available contextual data is associated with a patient medical history.

5. The user interface screen of claim 1, wherein the available contextual data is associated with a chronic disease.

6. The user interface screen of claim 1, wherein the available contextual data is associated with family history.

7. The user interface screen of claim 1, wherein the available contextual data is associated with a current medication.

8. The user interface screen of claim 1, wherein the available contextual data is associated with a social history.

9. The user interface screen of claim 1, further comprising a test link associated with the patient.

10. A system comprising:
a processor; and
storage coupled to the processor, the storage comprising:
instructions for accessing a patient record; and
instructions for providing a user interface screen, the user interface screen including a medical form component associated with a patient condition and a contextual link associated with available contextual data, the available contextual data associated with the patient condition.

11. The system of claim 10, further comprising a portable interface device configured to display the user interface screen.

12. The system of claim 10, wherein the network interface comprises a wireless network interface.

13. The system of claim 10, wherein the contextual link comprises a label indicative of the available contextual data.

14. The system of claim 10, wherein the contextual link is configured to access a second user interface screen associated with the available contextual data.

15. The system of claim 10, wherein the available contextual data is associated with a patient medical history.

16. The system of claim 10, wherein the available contextual data is associated with a chronic disease.

17. The system of claim 10, wherein the user interface screen further comprises a test link associated with a patient.

18. The system of claim 10, further comprising a database.

19. The system of claim 18, wherein the database includes the patient record.

20. The system of claim 19, wherein contextual link is derived from data stored in the patient record.

21. The system of claim 10, wherein the user interface screen comprises a combination of a template and patient data.

22. The system of claim 10, wherein the user interface screen further comprises a link to a study.

23. The system of claim 10, wherein the user interface screen is a history of present illness screen.

24. A medical interface comprising:
a plurality of interface pages;
wherein at least one page of the plurality of interface pages includes a present illness form component associated with a patient condition and a contextual link associated with the patient condition, the contextual link having a label indicative of available contextual data; and
wherein the contextual link is configured to access a second page associated with the available contextual data, the second page including a link to the at least one page that includes the present illness form component.

25. The medical interface of claim 24, wherein the available contextual data is associated with a patient medical history.

26. The medical interface of claim 24, wherein the available contextual data is associated with a chronic disease.

27. The medical interface of claim 24, wherein the at least one page further comprises a test link associated with a patient.

28. A method of providing a medical documentation interface, the method comprising:
receiving a request for an interface screen associated with a patient;
accessing data associated with the patient; and
providing the interface screen including a medical form component associated with a patient condition and a contextual link associated with available contextual data, the available contextual data being associated with the patient condition.

29. The method of claim 28, wherein the contextual link comprises a label indicative of the available contextual data.

30. The method of claim 28, wherein the contextual link is configured to access a second interface screen associated with the available contextual data.

31. The method of claim 28, wherein the available contextual data is associated with a patient medical history.

32. The method of claim 28, wherein the available contextual data is associated with a chronic disease.

33. The method of claim 28, wherein the interface screen is a history of present illness type of interface screen.

34. The method of claim 28, further comprising providing a second interface screen upon selection of the contextual link.

35. The method of claim 28, further comprising retrieving template data and patient data.

36. The method of claim 28, further comprising storing current encounter data.

37. An interface device comprising:
a display configured to display an interface screen comprising an interface form component associated with a patient condition and a contextual link associated with available contextual data, the available contextual data associated with the patient condition.

38. The interface device of claim 37, wherein the interface device is a computer tablet.

39. The interface device of claim 37, wherein the interface device is a personal digital assistant portable computer.
